(19) United States
(12) Patent Application Publication
(10) Pub. No.: US 2024/0161541 A1
(43) Pub. Date: May 16, 2024

(54) FACE RECOGNITION SYSTEM AND METHOD

(71) Applicant: DeCloak Intelligences Co., Taipei City (TW)

(72) Inventors: Yao-Tung Tsou, Taipei City (TW); Yun-Yu Wang, Taipei City (TW); Guo-Cheng Chien, Taipei City (TW); Kuo-Yu Chang, Taipei City (TW)

(73) Assignee: DeCloak Intelligences Co., Taipei City (TW)

(21) Appl. No.: 18/461,517

(22) Filed: Sep. 6, 2023

Related U.S. Application Data
(60) Provisional application No. 63/425,274, filed on Nov. 14, 2022.
(60) Provisional application No. 63/434,911, filed on Dec. 22, 2022.

(30) Foreign Application Priority Data
Jul. 20, 2023 (TW) 112127136

(51) Int. Cl. G06V 40/16; G06V 10/774; G06V 10/82

(52) U.S. Cl. CPC G06V 40/172; G06V 10/774; G06V 10/82; G06V 40/166

(57) ABSTRACT

A face recognition system and a face recognition method are provided. The face recognition system includes an image capturing device and a processing device. The image capturing device is configured to capture a face image of a user to be recognized, de-identify the face image to obtain de-identified image data, and transform the de-identified image data into multiple de-identified features and output. The processing device is configured to verify an identity of the user to which the de-identified features belong by using a trained machine learning model. The machine learning model is trained by using de-identified features and identities of multiple users registered in advance.

### CROSS-REFERENCE TO RELATED APPLICATION

This application claims the priority benefit of U.S. provisional application Ser. No. 63/425,274, filed on Nov. 14, 2022, U.S. provisional application Ser. No. 63/434,911, filed on Dec. 22, 2022, and Taiwan application serial no. 112127136, filed on Jul. 20, 2023. The entirety of each of the above-mentioned patent applications is hereby incorporated by reference herein and made a part of this specification.

### BACKGROUND

### Technical Field

The disclosure relates to a recognition system and method, and particularly relates to a face recognition system and method.

### Description of Related Art

Face recognition has become a cutting-edge solution in various industries due to its ability to secure access control, provide strong identity verification, promote goods and services, and speed up financial operations. However, these applications often come at the expense of user interests, such as privacy and even security. Even worse, face recognition for access control systems has caused companies to worry about leakage of their face database, which could violate privacy regulations and/or incur high maintenance costs.

Conventional solutions usually outsource all sensitive face data to a central server, or execute a decentralized model for local use. However, outsourced solutions violate privacy regulations by exposing user data to third-party service providers or insecure execution environments. On the other hand, although a local solution may protect user privacy to a certain extent, it still suffers from leakage of privacy due to device theft, and is limited by scalability, flexibility, and power consumption.

### SUMMARY

The disclosure is directed to a face recognition system and method, which are adapted to perform secure identity verification without leaking privacy.

The disclosure provides a face recognition system including an image capturing device and a processing device. The image capturing device is configured to capture a face image of a user to be recognized, de-identify the face image to obtain de-identified image data, and transform the de-identified image data into a plurality of de-identified features for output. The processing device is configured to verify an identity of the user to which the de-identified features belong by a trained first machine learning model. The first machine learning model is trained by using de-identified features and identities of a plurality of users registered in advance.

In some embodiments, the image capturing device includes: a lens; an image sensor, which senses an intensity of light passing through the lens to generate an image of a photographed object; an image signal processor, which captures a face image in the image, de-identifies the face image to obtain the de-identified image data, and transforms the de-identified image data into the plurality of de-identified features; and an input-output interface, which outputs the plurality of de-identified features.

In some embodiments, the image capturing device uses a second machine learning model that supports privacy protection technology to de-identify the face image.

In some embodiments, the second machine learning model includes a plurality of neurons divided into a plurality of layers, transforms the face image into feature values of the plurality of neurons of a first layer in the plurality of layers, adds the transformed feature values of each neuron to noise generated by using privacy parameters for inputting to a next layer, and obtain the de-identified image data after multi-layer processing.

In some embodiments, the privacy protection technology includes differential privacy, homomorphic encryption, shuffle or pixelate, etc.

In some embodiments, the first machine learning model includes calculating a similarity between the de-identified features and a feature space established by using the de-identified features of each user registered in advance, so as to verify the identity of the user to which the de-identified features belong according to the calculated similarity.

In some embodiments, the image capturing device is further configured to identify a living body in the face image by a living body recognition technology, and de-identify the face image when recognizing the living body in the face image, wherein the living body recognition technology includes eye blink detection, deep learning of features, a challenge-response technology or a 3D stereo camera.

In some embodiments, the processing device further processes the face image by image masking or face changing and outputs the processed face image by an input-output interface of the image capturing device.

In some embodiments, the first machine learning model is implemented by an application programming interface (API) attached to a processor of the processing device.

In some embodiments, the image capturing device and the processing device are integrated into a same device.

The disclosure provides a face recognition method, which is adapted to a face recognition system including an image capturing device and a processing device. The method includes: capturing a face image of a user to be recognized by the image capturing device; de-identifying the face image to obtain de-identified image data by the image capturing device; transforming the de-identified image data into a plurality of de-identified features for output by the image capturing device; and verifying an identity of the user to which the de-identified features belong by the processing device according to a trained first machine learning model, wherein the first machine learning model is trained by using de-identified features and identities of a plurality of users registered in advance.

In some embodiments, the step of de-identifying the face image to obtain the de-identified image data includes using a second machine learning model that supports privacy protection technology by the image capturing device to de-identify the face image.

In some embodiments, the second machine learning model includes a plurality of neurons divided into a plurality of layers, the step of de-identifying the face image to obtain the de-identified image data includes transforming the face image into feature values of the plurality of neurons of a first layer in the plurality of layers, adding the transformed feature values of each neuron to noise generated by using privacy parameters for inputting to a next layer, and obtaining the de-identified image data after multi-layer processing.

In some embodiments, the privacy protection technology includes differential privacy, homomorphic encryption, shuffle or pixelate, etc.

In some embodiments, the step of verifying the identity of the user to which the de-identified features belong by the processing device according to the trained first machine learning model includes calculating a similarity between the de-identified features and a feature space established by using the de-identified features of each user registered in advance, and verifying the identity of the user to which the de-identified feature belongs according to the calculated similarity.

In some embodiments, the feature space is obtained by an embedded space or a loss function, which includes optimizing a margin of a geodesic distance by normalizing a corresponding relationship between angles and radians in a hypersphere.

In some embodiments, the method further includes identifying a living body in the face image by a living body recognition technology, and de-identifying the face image when recognizing the living body in the face image.

In some embodiments, the living body recognition technology includes eye blink detection, deep learning of features, a challenge-response technology or a 3D stereo camera.

In some embodiments, the first machine learning model is implemented by an application programming interface (API) attached to a processor of the processing device.

In some embodiments, the method further includes processing the face image by image masking or face changing and outputting the processed face image by an input-output interface of the image capturing device.

Based on the above descriptions, the face recognition system and method of the disclosure de-identify the face image, and only upload the de-identified image data to the cloud for identification processing, and an actual photo of the user is not transmitted to the cloud, thus avoiding leakage of personal face images. In addition, high computing efficiency is achieved through cloud and edge computing acceleration.

To make the aforementioned more comprehensible, several embodiments accompanied with drawings are described in detail as follows.

### BRIEF DESCRIPTION OF THE DRAWINGS

FIG. 1 is a schematic diagram of a face recognition system according to an embodiment of the disclosure.

FIG. 2 is a schematic diagram of a face recognition method according to an embodiment of the disclosure.

FIG. 3 is a schematic diagram of a face recognition method according to an embodiment of the disclosure.

FIG. 4 is a schematic diagram of an access control system according to an embodiment of the disclosure.

FIG. 5 is a schematic diagram illustrating a structure of an image capturing device according to an embodiment of the disclosure.

FIG. 6A to FIG. 6C are schematic diagrams showing images displayed by an access control system according to an embodiment of the disclosure.

FIG. 7 is a schematic diagram of a face recognition method according to an embodiment of the disclosure.

FIG. 8 is a block diagram of a face recognition system according to an embodiment of the disclosure.

### DESCRIPTION OF THE EMBODIMENTS

In industries such as finance, healthcare, cryptocurrencies, and electronic signature platforms, ensuring privacy when collecting data is essential. The face recognition system of the embodiment of the disclosure is specially designed and constructed for cloud and edge computing, and an artificial intelligence (AI) recognition model is stored therein to achieve high computing efficiency. The embodiment of the disclosure further provides private secure identity verification, and image processing is only completed on a local device, and sensitive personal facial photos will not be uploaded to the cloud to avoid data leakage.

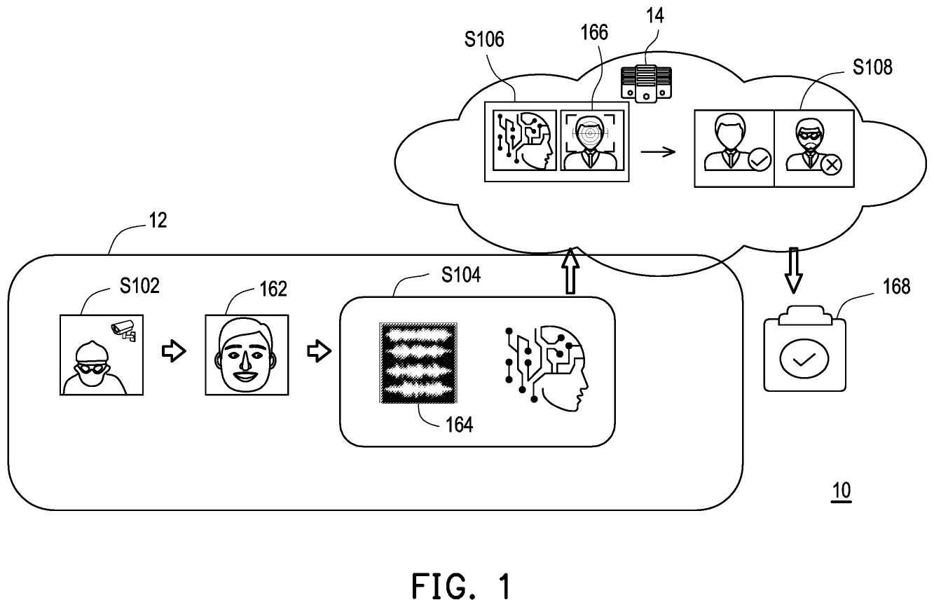

FIG. 1 is a schematic diagram of a face recognition system according to an embodiment of the disclosure. Referring to FIG. 1, the face recognition system 10 of the embodiment includes an image capturing device 12 and a processing device 14.

The image capturing device 12 is, for example, a device or apparatus located at a local end, which includes a charge coupled device (CCD), a complementary metal-oxide semiconductor (CMOS) device or other types of photosensitive device, which may sense light intensity to generate an image of a camera scene. The image capturing device 12 further includes a communication device supporting communication protocols such as wireless fidelity (Wi-Fi), radio frequency identification (RFID), Bluetooth, infrared, near-field communication (NFC) or device-to-device (D2D), etc., or a network connection device supporting Internet connection, which is used for communication or network connection with external devices. In some embodiments, the image capturing device 12 further includes an image signal processor (ISP), which may be used to process captured images.

The processing device 14 is, for example, a server, a workstation or other electronic devices located at a remote end, and the processing device 14 includes a communication device, a storage device, and a processor. For example, the communication device supports communication protocols such as wireless fidelity (Wi-Fi), radio frequency identification (RFID), Bluetooth, infrared, near-field communication (NFC) or device-to-device (D2D), etc., or supports Internet connection, which is used for communication or network connection with the image capturing device 12. The storage device is, for example, any type of fixed or removable random access memory (RAM), read-only memory (ROM), flash memory, hard disk or similar components or a combination of the above components, and is used for storing computer programs that may be executed by the processor. The processor is, for example, a central processing unit (CPU), or other programmable general purpose or special purpose microprocessor, microcontroller, digital signal processor (DSP), programmable controller, application specific integrated circuits (ASIC), programmable logic device (PLD) or other similar devices or a combination of these devices, which is not limited by the disclosure. In the embodiment, the processor may load a computer program from the storage device to execute the face recognition method of the embodiment of the disclosure. In some embodiments, the processor of the processing device 14 is provided with an application programming interface (API), which is embedded with a trained machine learning model and may be used to verify an identity of a user.

In step S102, the image capturing device 12 captures an image of a camera scene and performs face recognition to obtain a face image 162. Where, the image capturing device 12 may, for example, execute a face recognition algorithm on the captured image to capture the face image 162.

In step S104, the image capturing device 12 de-identifies the face image 162 to obtain de-identified image data 164 by a machine learning model that supports a privacy protection technology, and transforms the de-identified image data 164 into a plurality of de-identified features for outputting to the processing device 14. The aforementioned privacy protection technology includes differential privacy, homomorphic encryption, shuffle or pixelate, but the disclosure is not limited thereto.

In step S106, the processing device 16 trains the machine learning model by using de-identified features 166 and identities of a plurality of users registered in advance. The aforementioned machine learning model is, for example, a convolutional neural network (CNN), a deep neural network (DNN), a recurrent neural network (RNN) including an input layer, at least one hidden layer, and an output layer, or other models with a learning function, which is not limited by the disclosure.

In step S108, the processing device 16 verifies the identity of the user to which the de-identified features belong by the trained machine learning model, and outputs a verification result 168.

In some embodiments, the face recognition system 10, for example, adopts a loosely coupled deep neural network (DNN) as the machine learning model, and retains a small part of the neural layers on the local device/apparatus, and retains the rest in the cloud or a third-party server, so as to achieve an optimal choice of trade-off among computing resources, privacy loss and model quality.

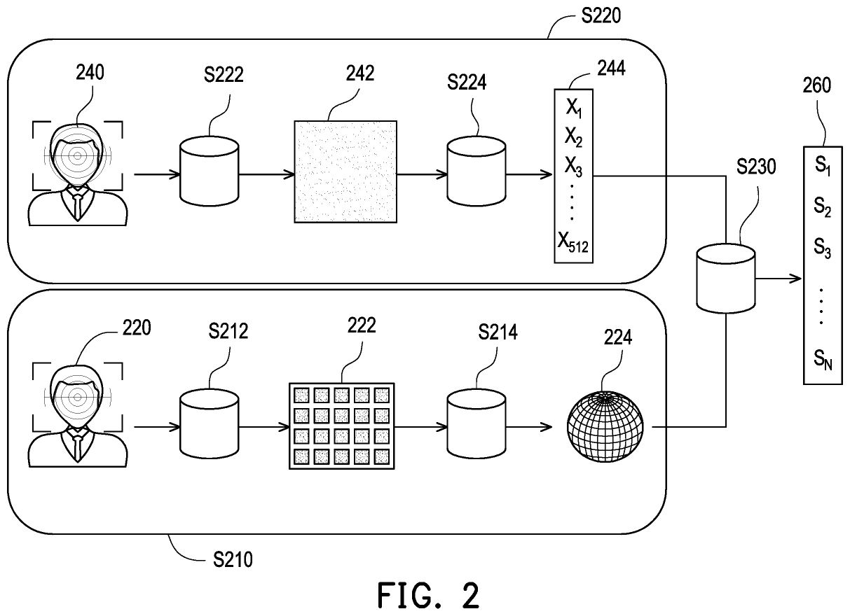

Based on a framework of the above-mentioned face recognition system, the face recognition system of the embodiment is divided into a registration phase and a recognition phase. FIG. 2 is a schematic diagram of a face recognition method according to an embodiment of the disclosure. Referring to FIG. 1 and FIG. 2 at the same time, the face recognition method of the embodiment is adapted to the face recognition system 10 in FIG. 1.

Step S210 is the registration phase, in step S212 of step S210, the image capturing device 12 inputs a plurality of captured face images 220 into a machine learning model (a second machine learning model) to generate a plurality of de-identified image data 222. The above-mentioned machine learning model includes a plurality of neurons divided into a plurality of layers, which transforms the face image into feature values of the plurality of neurons of a first layer in the plurality of layers, and adds the transformed feature value of each neuron to noise generated by using privacy parameters for inputting to a next layer, and obtains the de-identified image data after multi-layer processing.

In detail, the machine learning model of the embodiment is a neural network model that protects privacy through a privacy-preserving algorithm of a feature domain operation, i.e., Nₓᵢ+ [symbol] (0,ε²), where Nₓᵢ is specific data in the neural network, and K is the noise calculated by using a noise distribution or permutation algorithm with a privacy parameter e. It should be noted that Nₓᵢ is variable, which may be adjusted by the neural layer according to computing resources, privacy loss and model quality.

In step S214, the image capturing device 12 further executes data processing on the de-identified image data to convert the de-identified image data into a plurality of de-identified features for establishing a de-identified feature space 224. Where, the feature space is obtained, for example, by an embedded space or a loss function, such as AdaFace or ArcFace, etc., which includes optimizing a margin of a geodesic distance by normalizing a corresponding relationship between angles and radians in a hypersphere.

On the other hand, step S220 is the recognition phase, in step S222 of step S220, the image capturing device 12 inputs a currently captured face image 240 into the trained machine learning model to generate de-identified image data 242, and in step S224, the image capturing device 12 performs data processing on the de-identified image data 242 to transform the de-identified image data 242 into a plurality of de-identified features, so as to output a de-identified feature vector 244. In the embodiment, the de-identified feature vector 244 includes feature values X₁-X₅₁₂ of 512 features, but the disclosure is not limited thereto.

Step S230 is also in the recognition phase, where the processing device 14 verifies an identity of a user to which the de-identified features belong by the trained machine learning model (the first machine learning model). Where, the machine learning model is trained by using, for example, de-identified features and identities of a plurality of users registered in advance. In some embodiments, the processing device 14 calculates a similarity 260 between the de-identified features and the feature space established by using the de-identified features of each user registered in advance, including similarities S₁-S_{N}, where N is a positive integer, and verifies the identity of the user to which the de-identified features belong according to magnitudes of the similarities S₁-S_{N}.

However, in other embodiments, the processing device 14 may also use different activation functions such as an S (sigmoid) function and a hyperbolic tangent (tanh) function in a hidden layer of the machine learning model to calculate outputs of the neurons, and may use different transform functions such as a normalized exponential (softmax) function in an output layer to calculate prediction results, or may use a gradient descent (GD) method, a backpropagation (BP) method and other methods to update a weight of each neuron in the hidden layer, and the disclosure does not limit the way of using the machine learning model to verify the identity of the user.

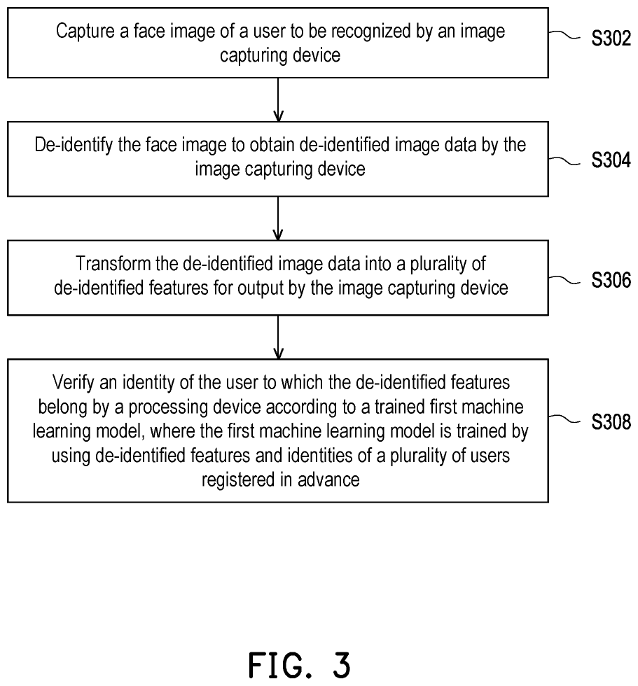

FIG. 3 is a schematic diagram of a face recognition method according to an embodiment of the disclosure. Referring to FIG. 1 and FIG. 3 at the same time, the face recognition method of the embodiment is applicable to the face recognition system 10 in FIG. 1.

In step S302, the face recognition system 10 captures a face image of a user to be recognized by the image capturing device 12.

In step S304, the image capturing device 12 de-identifies the face image to obtain de-identified image data. Where, the image capturing device 12, for example, de-identifies the face image by a machine learning model that supports privacy protection technology. The privacy protection technology includes differential privacy, homomorphic encryption, shuffle or pixelate, etc., but the disclosure is not limited thereto.

In step S306, the image capturing device 12 transforms the de-identified image data into a plurality of de-identified features for output.

In step S308, the processing device 14 verifies an identity of a user to which the de-identified features belong by the trained machine learning model. The machine learning model is trained, for example, by using de-identified features and identities of a plurality of users registered in advance. Where, the processing device 14, for example, calculates the similarity between the de-identified features and a feature space established by using the de-identified features of each user registered in advance by a machine learning model, so as to verify the identity of the user to which the de-identified features belong according to the calculated similarity.

In the embodiment, through acceleration of edge and cloud computing, face recognition may be performed efficiently, not only does it not require an account password or other hardware keys, but the face image of the user is not uploaded to the cloud in the form of an original image, so that identity verification may be performed safely without revealing personal information.

The design of the above-mentioned face recognition system is flexible, and may be easily integrated and interfaced with any existing system, and may also be customized according to specific needs. Enterprises in different industries may quickly and easily integrate the face recognition system of the embodiment into existing equipment or systems according to their own hardware equipment specifications and software requirements.

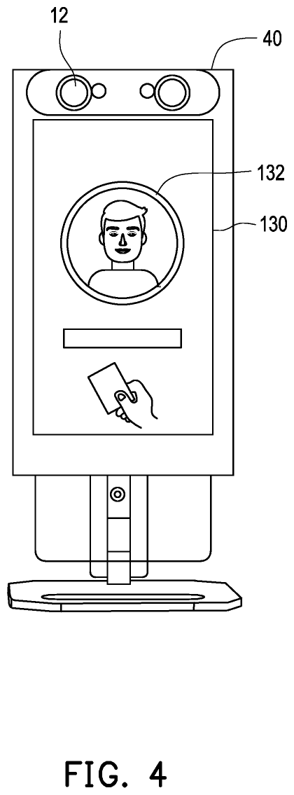

For example, the face recognition system may be integrated into an access control system to verify identities of personnel entering a gate or entrance. FIG. 4 is a schematic diagram of an access control system according to an embodiment of the disclosure. Referring to FIG. 4, the access control system 40 of the embodiment integrates the face recognition system 10 of FIG. 1 to verify an identity of a person intending to enter a gate or entrance, and accordingly opens the gate or allows the person to enter the entrance.

The access control system 40 includes an image capturing device 12, a display 130 and a transmission device (not shown). Where, the image capturing device 12 is configured to capture a face image of the user intending to enter the gate or entrance. The display 130 is configured to display a face image 132 captured by the image capturing device 12 or an image after de-identification, such as masking or face changing. The transmission device is configured to transmit the de-identified features generated by the image capturing device 12 to a cloud server to verify an identity of the user in the captured image, and receive a verification result from the server to decide whether to open the gate or allow the user to enter the entrance according to the verification result.

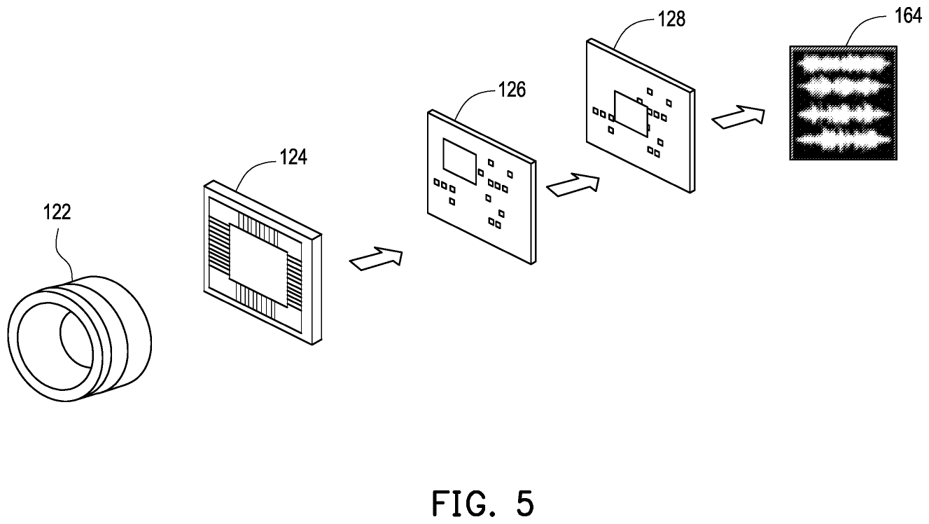

The image capturing device 12 is configured, for example, with an image signal processor (ISP) supporting a neural network to de-identify the captured face image 132. For example, FIG. 5 is a schematic diagram illustrating a structure of an image capturing device according to an embodiment of the disclosure. Referring to FIG. 5, the image capturing device 12 of the embodiment includes a lens 122, an image sensor 124, an image signal processor 126 and an input/output interface 128.

The lens 122 includes a plurality of optical lenses, which are driven by actuators such as stepping motors or voice coil motors to change relative positions of the lenses, thereby changing a focal length of the lens 122. The image sensor 124 is, for example, composed of a charge-coupled device (CCD), a complementary metal oxide semiconductor (CMOS) device or other types of photosensitive devices, and is disposed behind the lens 122 to sense an intensity of light incident on the lens 122 to generate an image of a photographed object.

The image signal processor 126 is configured to process the image generated by the image sensor 124, including executing a face recognition algorithm on the image to capture a face image. The image signal processor 126 has a built-in machine learning model for de-identifying the face image. The machine learning model includes a plurality of neurons divided into a plurality of layers, transforms the face image into feature values of the plurality of neurons of a first layer in the plurality of layers, adds the transformed feature values of each neuron to noise generated by using privacy parameters for inputting to a next layer, and generates the de-identified image data 164 after multi-layer processing. The input/output interface 128 is used for outputting the de-identified image data 164 output by the image signal processor 126.

In some embodiments, the de-identification processing performed on the face image by the face recognition system and method of the disclosure may include front-end image masking or face changing, and back-end face image data destruction.

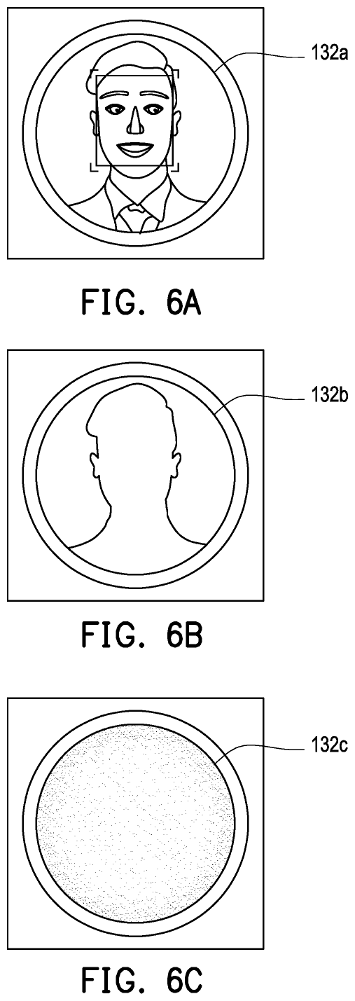

FIG. 6A to FIG. 6C are schematic diagrams showing images displayed by an access control system according to an embodiment of the disclosure. The embodiment illustrates the content of the image 132 displayed on the display 130 by the access control system 40 in FIG. 4.

As shown in FIG. 6A, the access control system 40 may display a real face image 132a of the user on the display 130, thereby letting the user know that his face has been clearly captured by the image capturing device 12. It should be noted that after the image capturing device 12 captures the face image of the user, the access control system 40 directly displays the face image on the display 130 without storing the face image, so as to prevent the original data of the face image from being stolen by others.

However, based on the fact that the face image displayed on the front end involves the user's privacy, when the user sees his own image on the display 130, even if the image is not stored, the user may feel that his privacy has been violated. In this regard, as shown in FIG. 6B, the access control system 40 may only display a profile 132b of the user on the display 130, or adopt a method of adding an image mask or changing the face. In this way, the user may also learn that his face has been captured by the image capturing device 12, and the user's privacy may be protected.

Alternatively, based on the de-identification and other destructive processing of the face image data at the back end, as shown in FIG. 6C, the access control system 40 may display a de-identified face image 132c of the user on the display 130, thereby further protecting the user's privacy. Where, since the original image is not stored, the de-identified face image 132c is not generated by using the stored original image, so that the original image may be prevented from being leaked to cause privacy violation.

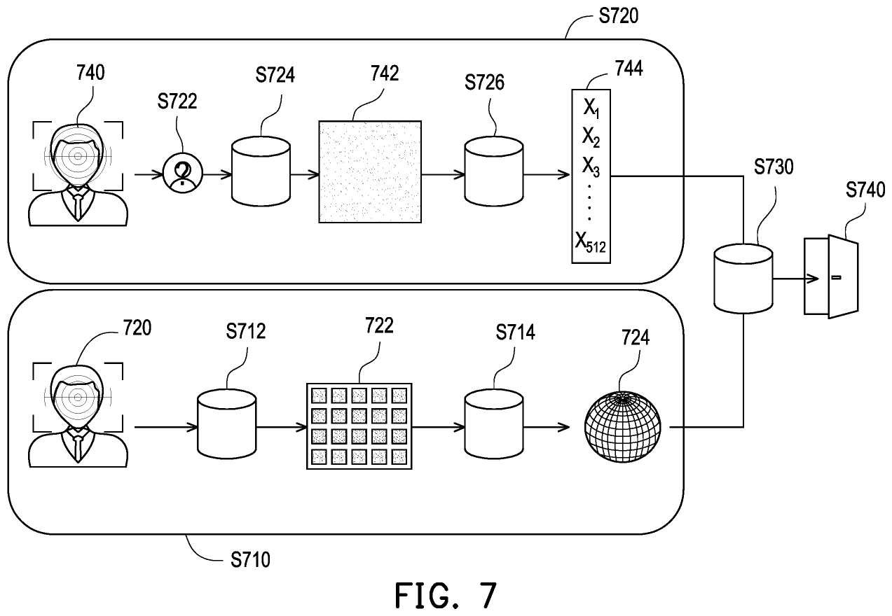

FIG. 7 is a schematic diagram of a face recognition method according to an embodiment of the disclosure. Referring to FIG. 1 and FIG. 7 at the same time, the face recognition method of the embodiment is applied to the access control system 40 in FIG. 4, which may also be divided into the registration phase and the recognition phase.

Step S710 is the registration stage, in step S712 of step S710, the image capturing device 12 inputs a plurality of captured face images 720 into the machine learning model to generate a plurality of de-identified image data 722.

In step S714, the image capturing device 12 further executes data processing on the de-identified image data, so as to transform the de-identified image data into a plurality of de-identified features for establishing a de-identified feature space 724.

Step S720 is the recognition phase, in step S722 of step S720, the image capturing device 12 identifies a living body in a currently captured face image 740 by a living body recognition technology. In this way, it may prevent others from obtaining the face image in advance and using the face image to deceive the system. The living body recognition technology includes blink detection, deep learning of features, challenge-response technology or three-dimensional stereo camera, but the disclosure is not limited thereto.

If it is recognized that there is a living body in the current face image 740, in step S724, the image capturing device 12 inputs the currently captured face image 740 into the trained machine learning model to generate de-identified image data 742, and in step S726, the image capturing device 12 performs data processing on the de-identified image data 742 to transform the de-identified image data 742 into a plurality of de-identified features, thereby outputting a de-identified feature vector 744.

Step S730 is also in the recognition phase, where the processing device 14 verifies an identity of a user to which the de-identified features belong by the trained machine learning model. The machine learning model is trained by, for example, de-identified features and identities of a plurality of users registered in advance. The processing device 14, for example, calculates a similarity between the de-identified features and a feature space established by using the de-identified features of each user registered in advance, and verifies the identity of the user to which the de-identified features belong according to the calculated similarity.

If the verified user identity matches one of identities of the registered users, in step S740, the processing device 14 controls the access control system 40 to open the gate or allow the user to enter the entrance.

In some embodiments, the face recognition system may be integrated into a single device for implementation. For example, the face recognition system may be integrated into electronic devices such as notebook computers or desktop computers, and may verify the identity of the user while protecting the face image of the user from being stolen.

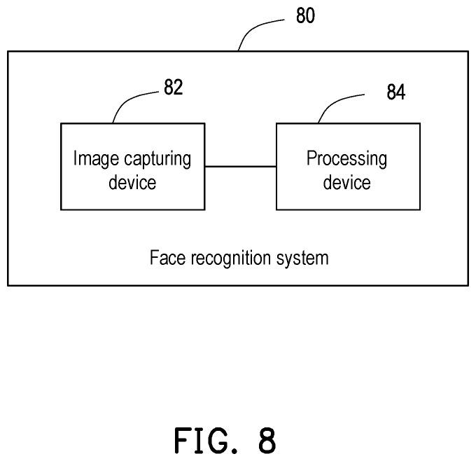

FIG. 8 is a block diagram of a face recognition system according to an embodiment of the disclosure. Referring to FIG. 8, a face recognition system 80 of the embodiment includes an image capturing device 82 and a processing device 84. Where, functions of the image capturing device 82 and the processing device 84 are the same or similar to those of the image capturing device 12 and the processing device 14 in the aforementioned embodiment, so that details thereof are not repeated here.

Different from the aforementioned embodiments, in the embodiment, the face recognition system 80 may be a system running on a computer. Namely, the image capturing device 82 and the processing device 84 are integrated into a same device.

The image capturing device 82 includes an image signal processor (ISP) supporting a neural network, in which an artificial intelligence (AI)-driven machine learning model is embedded, which may de-identify the captured face image to obtain de-identified image data, and transform the de-identified image data into a plurality of de-identified features.

The processing device 84 is, for example, connected by an interface device such as a universal serial bus (USB) or a system bus, and a processor of the processing device 84 is provided with an application programming interface (API), and a trained machine learning model is embedded therein, where the machine learning model is, for example, trained by using de-identified features and identities of a plurality of users registered in advance, and may be used to verify an identity of a user to which the de-identified features belong. Where, the processing device 84, for example, calculates the similarity between the de-identified features and the feature space established by using the de-identified features of each user registered in advance by a machine learning model, so as to verify the identity of the user to which the de-identified features belong according to the calculated similarity.

In summary, the face recognition system and method of the disclosure have the following characteristics:

The face recognition system has a privacy-preserving deep neural network (DNN) processing scheme for face recognition, which is easy to integrate with existing multi-factor identity verification systems.

The face recognition system is an offload system that may perform DNN training and recognition tasks in a private manner by designing a privacy-preserving algorithm for triggering operations.

The face recognition system adopts an optimized DNN separation strategy to keep the first layer from being unloaded, which is the best choice for the trade-off among computing resources, privacy loss and model quality.

Any image data transmitted from the terminal device will be de-identified and invisible. At the same time, in the case that a false accept rate (FAR) is 10⁻⁶, the prediction/verification accuracy of the face recognition system may be maintained above 99%.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A face recognition system, comprising:
an image capturing device, configured to capture a face image of a user to be recognized, de-identify the face image to obtain de-identified image data, and transform the de-identified image data into a plurality of de-identified features for output; and
a processing device, configured to verify an identity of the user to which the de-identified features belong by a trained first machine learning model, wherein the first machine learning model is trained by using de-identified features and identities of a plurality of users registered in advance.

2. The face recognition system according to claim 1, wherein the image capturing device comprises:
a lens;
an image sensor, configured to sense an intensity of light passing through the lens to generate an image of a photographed object;
an image signal processor, configured to capture the face image in the image, de-identify the face image to obtain the de-identified image data, and transform the de-identified image data into the plurality of de-identified features; and
an input-output interface, configured to output the plurality of de-identified features.

3. The face recognition system according to claim 1, wherein the image capturing device uses a second machine learning model that supports privacy protection technology to de-identify on the face image.

4. The face recognition system according to claim 3, wherein the second machine learning model comprises a plurality of neurons divided into a plurality of layers, transforms the face image into feature values of the plurality of neurons of a first layer in the plurality of layers, adds the transformed feature values of each neuron to noise generated by using privacy parameters for inputting to a next layer, and obtains the de-identified image data after a multi-layer processing.

5. The face recognition system according to claim 3, wherein the privacy protection technology comprises differential privacy, homomorphic encryption, shuffle, or pixelate, etc.

6. The face recognition system according to claim 1, wherein the first machine learning model comprises calculating a similarity between the de-identified features and a feature space established by using the de-identified features of each user registered in advance, so as to verify the identity of the user to which the de-identified features belong according to the calculated similarity.

7. The face recognition system according to claim 1, wherein the image capturing device is further configured to identify a living body in the face image by a living body recognition technology and de-identify the face image when recognizing the living body in the face image, wherein the living body recognition technology comprises eye blink detection, deep learning of features, a challenge-response technology, or a 3D stereo camera.

8. The face recognition system according to claim 1, wherein the processing device further processes the face image by image masking or face changing and outputs the processed face image by an input-output interface of the image capturing device.

9. The face recognition system according to claim 1, wherein the first machine learning model is implemented by an application programming interface (API) attached to a processor of the processing device.

10. The face recognition system according to claim 1, wherein the image capturing device and the processing device are integrated into a same device.

11. A face recognition method, adapted to a face recognition system comprising an image capturing device and a processing device, wherein the face recognition method comprises:
capturing a face image of a user to be recognized by the image capturing device;
de-identifying the face image to obtain de-identified image data by the image capturing device;
transforming the de-identified image data into a plurality of de-identified features for output by the image capturing device; and
verifying an identity of the user to which the de-identified features belong by the processing device according to a trained first machine learning model, wherein the first machine learning model is trained by using de-identified features and identities of a plurality of users registered in advance.

12. The face recognition method according to claim 11, wherein the step of de-identifying the face image to obtain the de-identified image data comprises:
using a second machine learning model that supports privacy protection technology by the image capturing device.

13. The face recognition method according to claim 12, wherein the second machine learning model comprises a plurality of neurons divided into a plurality of layers, and the step of de-identifying the face image to obtain the de-identified image data comprises:
transforming the face image into feature values of the plurality of neurons of a first layer in the plurality of layers, adding the transformed feature values of each neuron to noise generated by using privacy parameters for inputting to a next layer, and obtaining the de-identified image data after a multi-layer processing.

14. The face recognition method according to claim 12, wherein the privacy protection technology comprises differential privacy, homomorphic encryption, shuffle, or pixelate, etc.

15. The face recognition method according to claim 11, wherein the step of verifying the identity of the user to which the de-identified features belong by the processing device according to the trained first machine learning model comprises:
calculating a similarity between the de-identified features and a feature space established by using the de-identified features of each user registered in advance; and
verifying the identity of the user to which the de-identified features belong according to the calculated similarity.

16. The face recognition method according to claim 15, wherein the feature space is obtained by an embedded space or a loss function, which comprises optimizing a margin of a geodesic distance by normalizing a corresponding relationship between angles and radians in a hypersphere.

17. The face recognition method according to claim 11, further comprising:
identifying a living body in the face image by a living body recognition technology, and de-identifying the face image when recognizing the living body in the face image.

18. The face recognition method according to claim 17, wherein the living body recognition technology comprises eye blink detection, deep learning of features, a challenge-response technology, or a 3D stereo camera.

19. The face recognition method according to claim 11, wherein the first machine learning model is implemented by an application programming interface (API) attached to a processor of the processing device.

20. The face recognition method according to claim 11, further comprising processing the face image by image masking or face changing and outputting the processed face image by an input-output interface of the image capturing device.
